(19) United States
(12) Patent Application Publication
(10) Pub. No.: US 2012/0021829 A1
(43) Pub. Date: Jan. 26, 2012

(54) PHOTOGRAPHIC SOCIAL GAME METHOD, SYSTEM, AND APPARATUS

(75) Inventors: Yoav Shoham, Los Altos Hills, CA (US); Shailendra Ramineni Rao, East Palo Alto, CA (US); Michael Andrew Munie, Palo Alto, CA (US); Thuc D. Vu, Palo Alto, CA (US)

(73) Assignee: KATANGO, INC., PALO ALTO, CA (US)

(21) Appl. No.: 13/187,088

(22) Filed: Jul. 20, 2011

Related U.S. Application Data
(60) Provisional application No. 61/366,463, filed on Jul. 21, 2010.

(51) Int. Cl. A63F 13/00; G09G 5/00

(52) U.S. Cl. 463/31; 345/634

(57) ABSTRACT

A game machine may facilitate a photographic social game. The photographic social game may be played using, for example, camera-enabled devices (e.g., participating devices). The photographic social game may prompt users of camera-enabled devices to take and submit photographs at a particular time (e.g., 5:00 PM GMT or 5:00 PM local time), after occurrence of a particular event (e.g., 5 minutes after waking up), or any suitable combination thereof. These photos may be assembled by the game machine into a presentation that is shared among the users participating in the photographic social game, and one or more of various games may be played by the users based on the presentation.

### RELATED APPLICATIONS

This application claims the priority benefit of U.S. Provisional Application No. 61/366,463, filed Jul. 21, 2010, which is incorporated herein by reference in its entirety.

### TECHNICAL FIELD

The subject matter disclosed herein generally relates to amusements and games.

### BACKGROUND

A device may be used for communication by a user of the device. For example, a device may be a portable device (e.g., a mobile device), and the device may be carried by the user or otherwise kept near the user for convenient use in sending or receiving communications.

Modern devices may include a camera that can be used to generate an image (e.g., a photographic image). For example, a device may be a cellular telephone with a built-in camera that is able to take a photograph and store the photograph on the cellular telephone (e.g., in a memory of the cellular telephone).

Accordingly, a device may be a communication device with a camera, and the device may be used to generate an image and then communicate the image (e.g., via a network). As an example, a user may operate a cellular telephone with a built-in camera to take a photograph and transmit the photograph to another cellular telephone belonging to a different user, where the photograph is transmitted via a cellular network accessible by the two cellular telephones.

### BRIEF DESCRIPTION OF THE DRAWINGS

Some embodiments are illustrated by way of example and not limitation in the figures of the accompanying drawings.

FIG. 1-8 are screenshots from a device participating in a photographic social game, according to some example embodiments.

FIG. 9 is a layout diagram of a presentation generated based on images received from devices participating in the photographic social game, according some example embodiments.

FIG. 10 is a screenshot showing the presentation within a web page corresponding to a photographic social game, according to some example embodiments.

FIG. 11 is a network diagram illustrating a network environment suitable for facilitating a photographic social game, according to some example embodiments.

FIG. 12 is a block diagram illustrating components of a game machine configured to facilitate a photographic social game, according to some example embodiments.

FIG. 13-15 are flowcharts illustrating operations in a method of facilitating a photographic social game, according to some example embodiments.

FIG. 16 is a block diagram illustrating components of a machine, according to some example embodiments, able to read instructions from a machine-readable medium and perform any one or more of the methodologies discussed herein.

### DETAILED DESCRIPTION

Example methods, systems, and apparatus are directed to photographic social gaming. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A game machine facilitates a photographic social game that may be played using, for example, camera-enabled devices (e.g., participating devices). The photographic social game asks that users of camera-enabled devices take and submit photographs at a particular time (e.g., 5:00 PM GMT or 5:00 PM local time), after an occurrence of a particular event (e.g., 5 minutes after waking up), or any suitable combination thereof. These photos may be assembled by the game machine into a presentation, and one or more of various games may be played by the users based on the presentation.

The game machine causes prompts to appear on the participating devices belonging to contributory users, where the prompts serve as reminders to take and submit photos for the photographic social game. The game machine receives images from the participating devices in response to the prompts being shown. Each of the images is generated by one of the participating devices in response to one of the prompts being shown by that participating device. The game machine generates a presentation of images based on the received images, and the received images may appear in the presentation. For example, the presentation may take the form of a single image in which the images are arranged as a collage, a grid, a mosaic, or any suitable combination thereof. As other examples, the presentation may take the form of an album in which the images are arranged in groups (e.g., as multiple sets of multiple images), an electronic book in which the images are arranged as pages of the electronic book, a slideshow in which the images are arranged as slides in the slideshow, a video in which the images appear (e.g., one at a time or several at a time), or any suitable combination thereof. The game machine then provides the presentation to the participating devices from which the images were received (e.g., as a communication to the participating devices or as a communication to a server machine of the social media service provider for one or more contributory users). Also, the game machine may provide the presentation to non-participating devices (e.g., as a publicly accessible web page) belonging to non-contributory users.

The game machine may facilitate a guessing game in which a contributory user who submitted an image to the game machine from a participating device may submit an identifier (e.g., a name or username) of a further contributory user who submitted a further image. The game machine may receive the identifier as a guess at who submitted the further image, and the game machine may award points to the contributor user by updating a score of the contributory user based on the submitted identifier.

The game machine may facilitate a rating game in which contributory users, non-contributory users (who submitted none of the images), or both, submit ratings of one or more images appearing in the presentation provided by the game machine. Accordingly, the game machine may receive a rating of an image as a submission from a contributory user, from a non-contributory user, or any suitable combination thereof. For example, the rating may indicate a quality of the presentation (e.g., as a whole), a quality of a particular image appearing in the presentation (e.g., as a standalone image), or any suitable combination thereof. Based on one or more received ratings, the game machine may award points to multiple contributory users (e.g., for participation in the photographic social game), to the contributory user who submitted the particular image (e.g., for submitting that particular image), or any suitable combination thereof.

The photographic social game may be facilitated by instructions (e.g., software) executing on one or more of the participating devices, and the game machine may provide instructions to one or more of the participating devices. The instructions may cause a participating device to show a prompt (e.g., reminder) related to contributing images for the photographic social game. For example, the game machine may act as a server machine that provides a mobile application to a mobile device. Additional details of the game machine are discussed below.

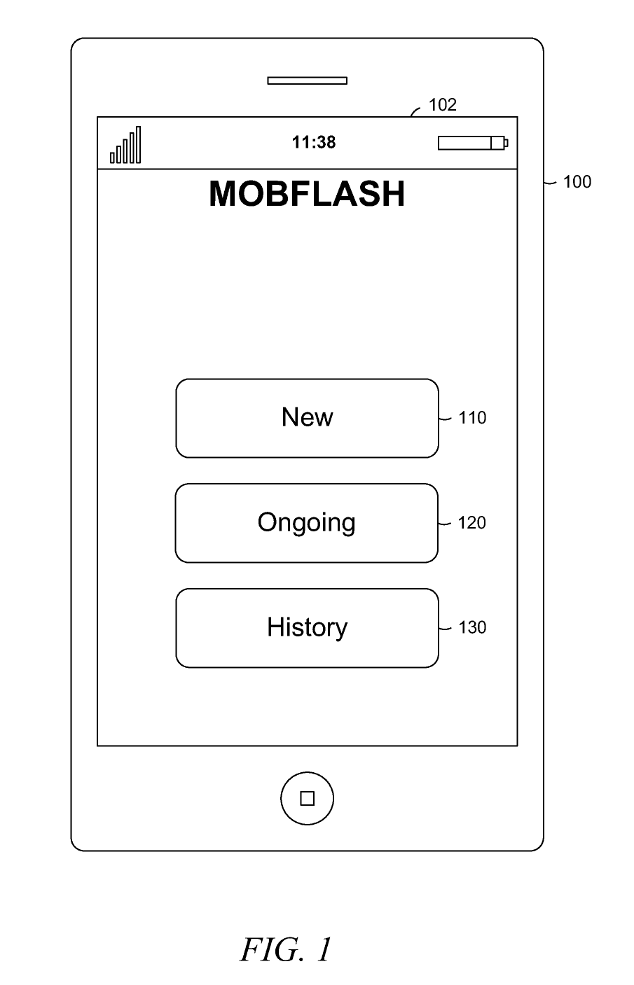

FIG. 1-8 are screenshots from a device 100 participating in a photographic social game, according to some example embodiments. In FIG. 1-8, the device 100 includes a display 102 (e.g., an electronic display screen). The device 100 may be a device (e.g., a mobile smartphone) that is a participating device belonging to a contributory user for purposes of the photographic social game. Instructions provided by the game machine (e.g., a mobile application or app) may be executed by the device 100 to cause the display 102 to take on any one or more of the appearances shown in FIG. 1-8.

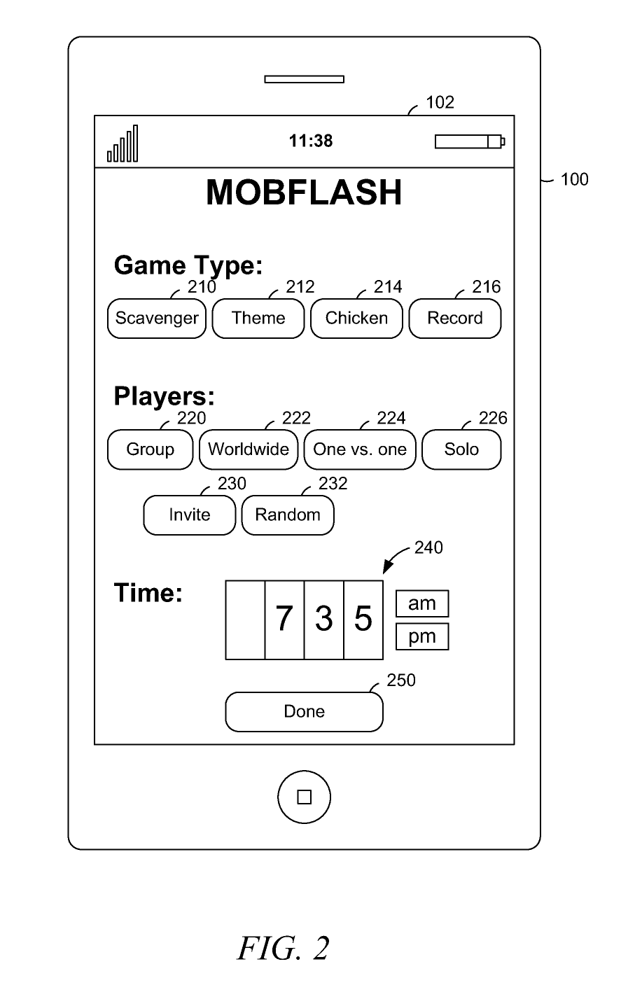

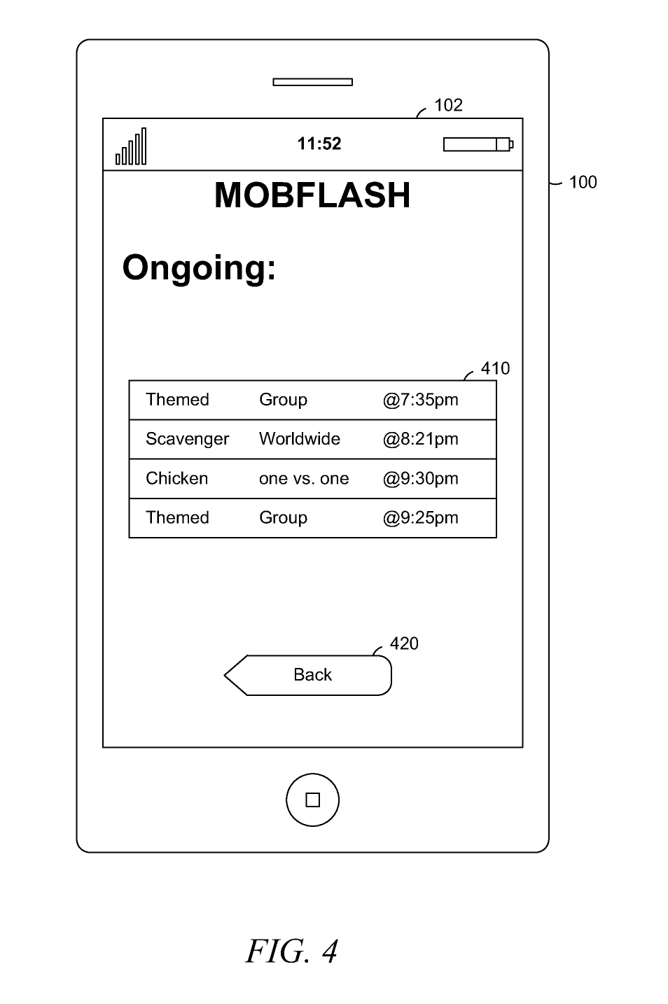

In FIG. 1, the display 102 shows a title of the photographic social game (e.g., “MOBFLASH”), a new game button 110, an ongoing games button 120, and a game history button 130, according to some example embodiments. Activation of the new game button 110, in some example embodiments, causes the display 102 to take on the appearance shown in FIG. 2. Activation of the ongoing games button 120, in some example embodiments, causes the display 102 to take on the appearance shown in FIG. 4. Activation of the game history button 130, in some example embodiments, causes the display 102 to show one or more records of previous (e.g., completed, expired, or aborted) games.

In FIG. 2, the display 102 shows game type buttons 210, 212, 214, and 216, according to some example embodiments. Each of the game type buttons 210, 212, 214, and 216 is operable by a user of the device 100 to select a game type for a new game (e.g., a new instance of the photographic social game) to be organized using the device 100. Examples of game types, as shown in FIG. 2, include “scavenger,” “theme,” “chicken,” and “record.”

Also shown in FIG. 2 are invitation format buttons 220, 222, 224, 226, 230, and 232. Each of the invitation format buttons 220, 222, 224, 226, 230, and 232 is operable by a user of the device 100 to select a methodology or format for inviting contributory users (e.g., players) to participate in the photographic social game and contribute images toward generation of a presentation for the photographic social game. Examples of methodologies or formats for inviting contributory users, as shown in FIG. 2, include “group,” “worldwide,” “one vs. one,” “solo,” “invite” (e.g., manual invitation), and “random” (e.g., random invitation).

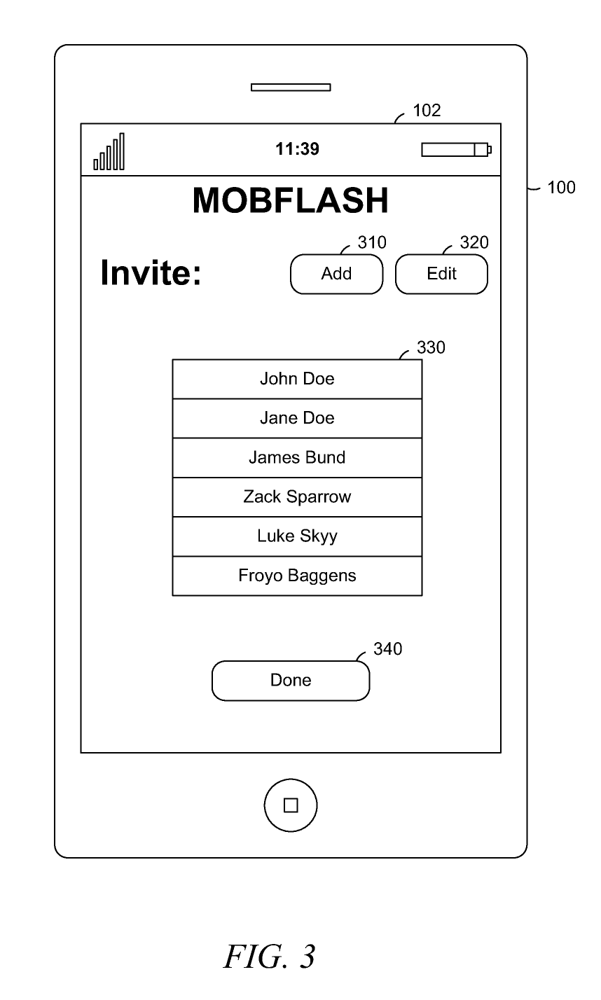

Additionally shown in FIG. 2 are a time interface 240 and an execution button 250 (e.g., “done”). The time interface 240 is operable by a user of the device 100 to select a time at which images are to be generated by participating devices, at which the images are to be submitted to the game machine (e.g., functioning as a server machine for the photographic social game), or both. The execution button 250 is operable by the user of the device 100 to accept the selections of the game type, the invitation format, and the time. Activation of the execution button 250, in some example embodiments, causes the display 102 to take on the appearance shown in FIG. 3.

In FIG. 3, the display 102 shows a contact addition button 310 (e.g., “add”), a contact edit button 320 (e.g., “edit”), a list 330 of contacts, and an execution button 340 (e.g., “done”), according to some example embodiments. The list 330 of contacts may be all or part of a database of contacts stored at the device 100 (e.g., a database of Microsoft® Office Outlook® contacts). In some example embodiments, all or part of the list 330 of contacts may be generated or suggested by a machine (e.g., the game machine), for example, using artificial intelligence, machine-learning, or any suitable combination thereof. Activation of the contact addition button 310 may select one or more of the contacts shown in the list 330 of contacts for invitation to participate in an instance of the photographic social game being organized from the device 100. Activation of the contact edit button 320 may select one or more of the contacts shown in the list 330 of contacts for modification. The execution button 340 is operable by the user of the device 100 to accept the selections of contacts. Activation of the execution button 340, in some example embodiments, causes the game machine to organize the instance of the photographic social game and send invitations to the selected contacts.

In FIG. 4, the display 102 shows a list 410 of ongoing games (e.g., ongoing instances of the photographic social game) and a back button 420 (e.g., “back”), according to some example embodiments. The list 410 of ongoing games indicates details of instances. Examples of such details include game type (e.g., “themed,” “scavenger,” or “chicken”), invitation format (e.g., “group,” “worldwide,” or “one vs. one”), and time (e.g., “7:35 pm”). Activation of the back button 420 causes the display 102 to revert to the appearance shown in FIG. 1.

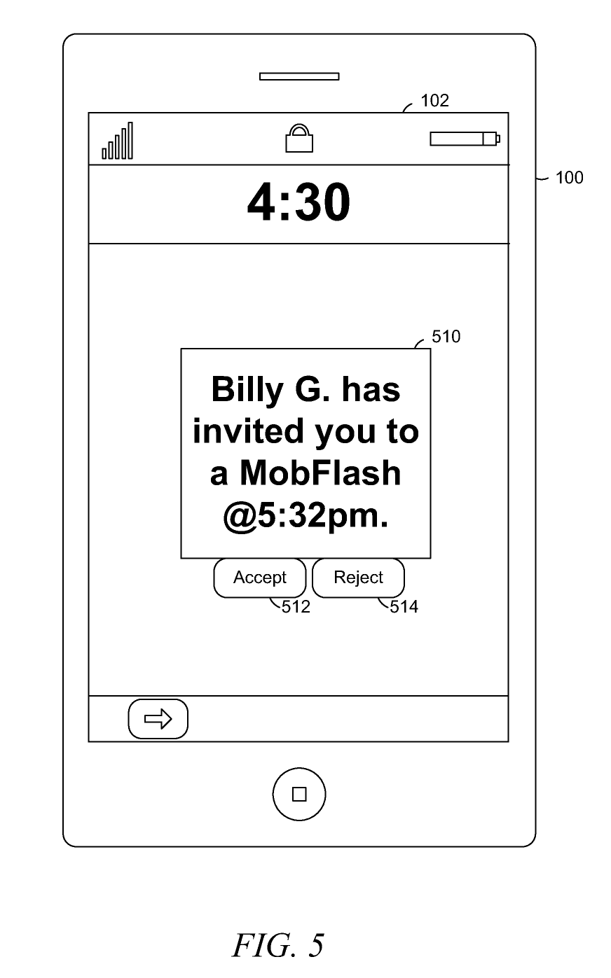

In FIG. 5, the display 102 shows an invitation 510 to a newly organized instance of the photographic social game, according to some example embodiments. Although the invitation 510 is shown as appearing on the display 102 of the device 100, the invitation 510 may appear on a device (e.g., a participating device) belonging to any invited user (e.g., a contributing user). The display 102 also shows an accept button 512 and a reject button 514. The accept button 512 is operable by a user of the device 100 to accept the invitation 510 and accordingly agree to participate in the instance of the photographic social game. For example, operation of the accept button 512 may communicate an affirmative (e.g., accepting) response to the invitation 510. The reject button 514 is operable by the user of the device 100 to reject the invitation 510 and choose not to participate in the instance of the photographic social game. As an example, operation of the reject button 514 may communicate a negative (e.g., declining) response to the invitation 510.

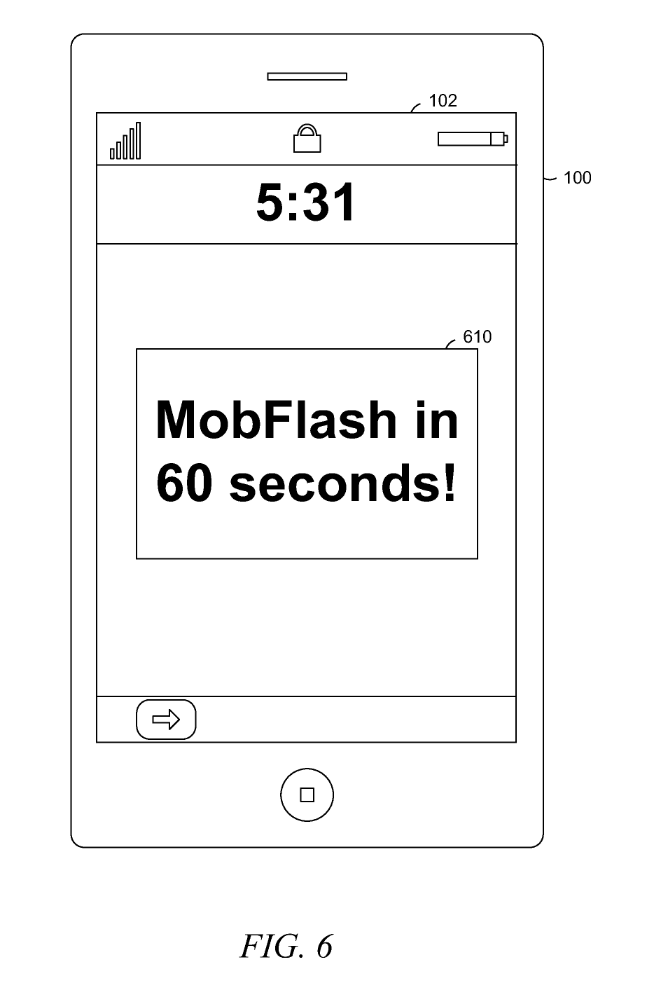

In FIG. 6, the display 102 shows a prompt 610, according to some example embodiments. The prompt 610 functions as a reminder that the time at which images are to be generated or submitted is approaching.

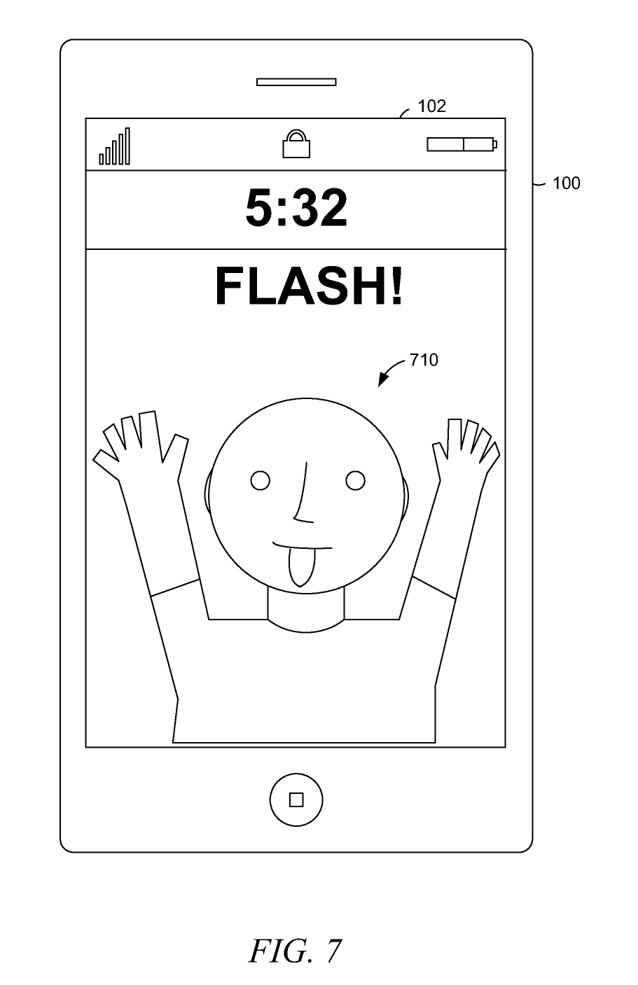

In FIG. 7, the display 102 shows a subject 710 being photographed by the device 100 (e.g., by the user of the device 100) as an example of an image being generated by the device 100. The image of the subject 710 may be processed (e.g., stylized with cropping, texture edition, filtering, or other photographic effects) by the device 100 (e.g., using stylizing software executing on the device 100).

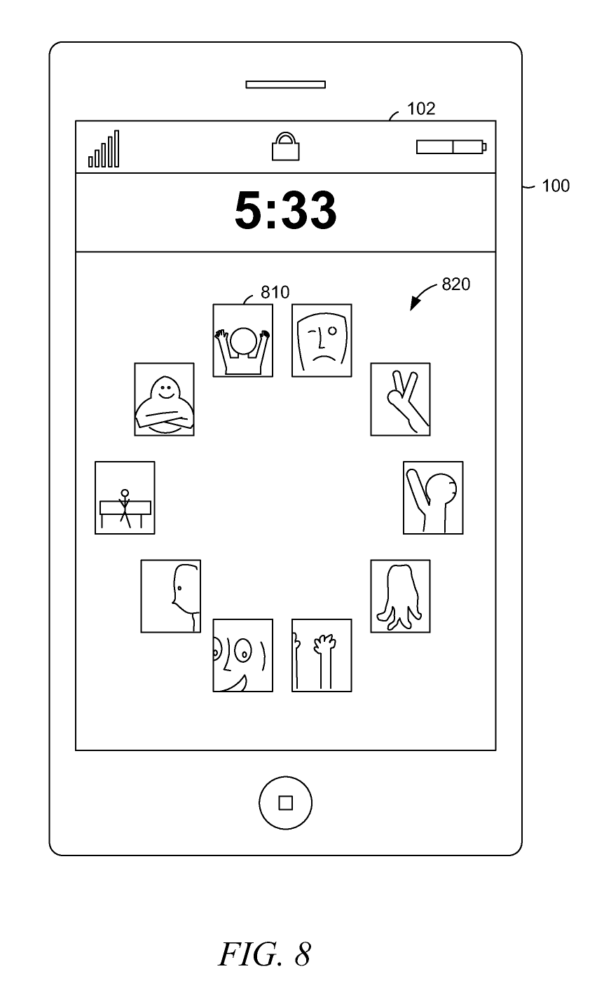

In FIG. 8, the display 102 shows a presentation 820 of images, according to some example embodiments. The game machine receives a set of images from multiple participating devices (e.g., device 100) and generates the presentation 820 based on (e.g., from) the received set of images. The game machine provides the presentation 820 to one or more of the multiple participating devices. As shown in FIG. 8, the presentation 820 of images includes an image 810 of the subject 710, along with other images received by the game machine.

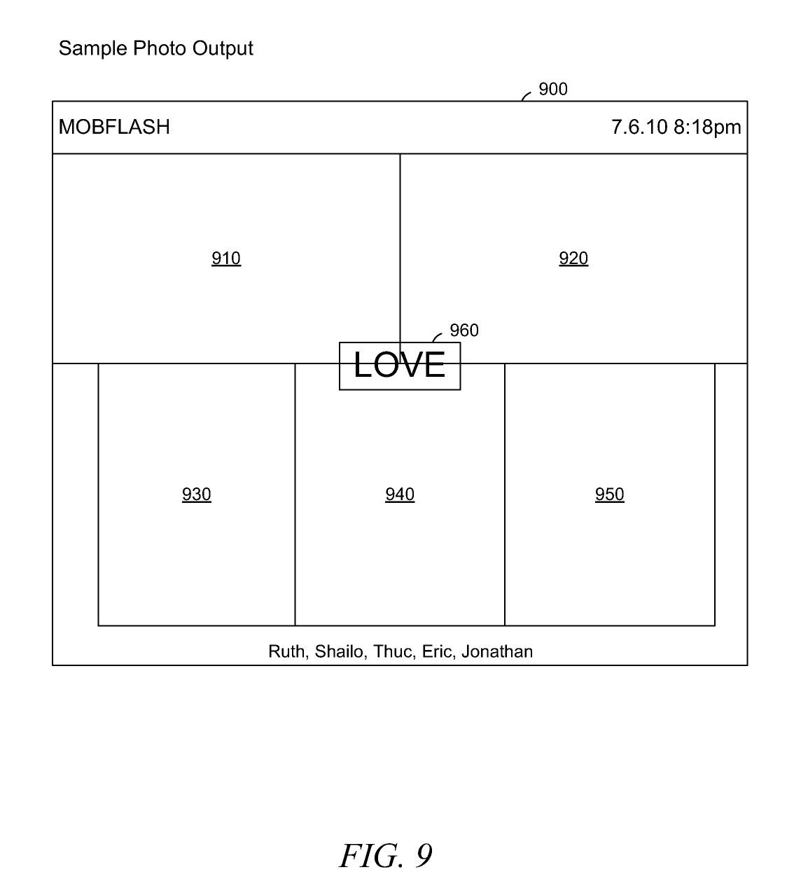

FIG. 9 is a layout diagram of another presentation 900 of images, according some example embodiments. The presentation 900 is generated based on images received from multiple participating devices (e.g., device 100) and is provided by the game machine to one or more of the multiple participating devices. In some example embodiments, the presentation 900 may be provided by the game machine to one or more non-participating devices (e.g., as or within a publicly accessible web page). The presentation 900 includes images 910, 920, 930, 940, and 950. Each of the images 910, 920, 930, 940, and 950 is generated by a participating device and submitted to the game machine by the participating device. The presentation 900 also includes a theme 960 (e.g., “LOVE”). The theme 960 may be a descriptor used by one or more contributory users in selecting subjects (e.g., subject 710) of photography for the photographic social game.

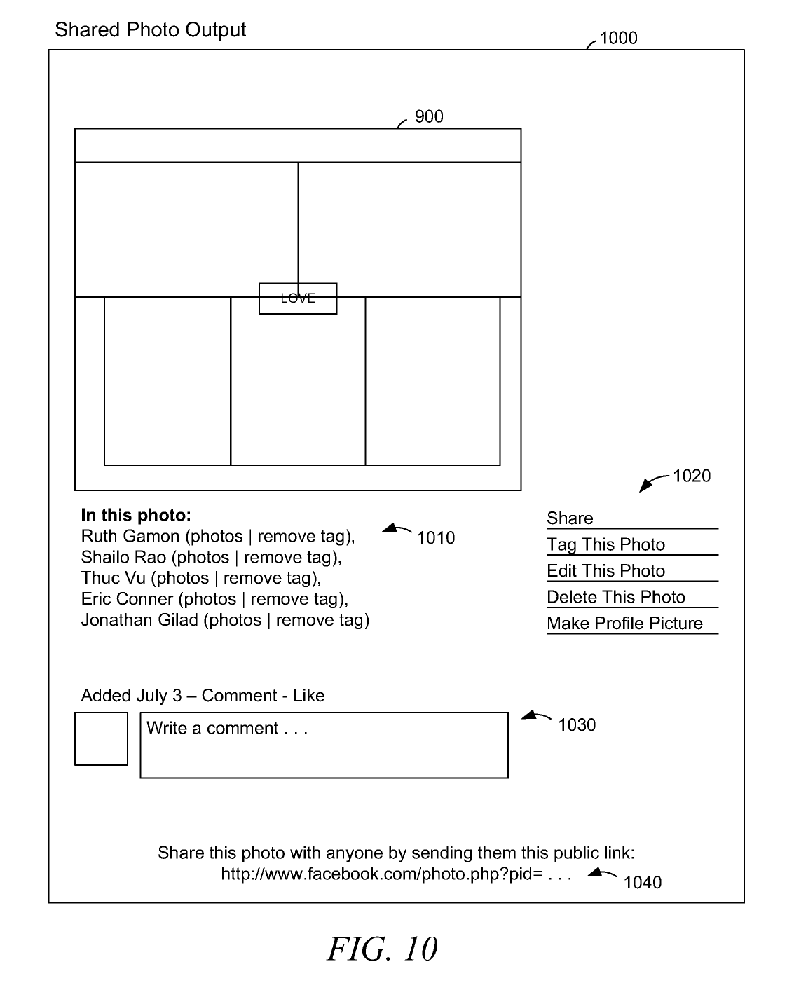

FIG. 10 is a screenshot showing the presentation 900 within a web page 1000 corresponding to the photographic social game, according to some example embodiments. The web page 1000 is an example of a document accessible by participating devices (e.g., device 100) of contributory users, non-participating devices of non-contributory users, or any suitable combination thereof. The presentation 900 may be scaled to fit within the web page 1000. The web page 1000 also includes one or more identifiers 1010 of contributory users (e.g., “Ruth Gamon”), one or more actions 1020 available to viewers of the web page 1000, and a submission interface 1030 operable to submit information (e.g., a descriptor, comment, or tag) pertinent to all or part of the presentation 900. The web page 1000 further includes a locator 1040 usable to access (e.g., request or retrieve) the presentation 900, the web page 1000, or both.

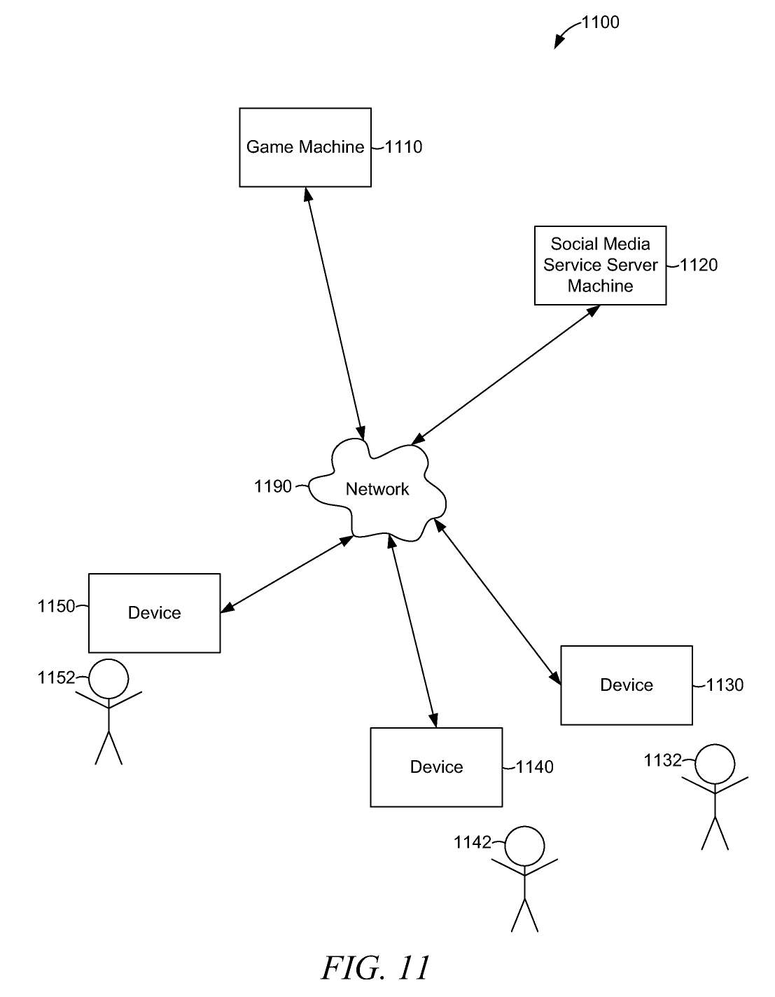

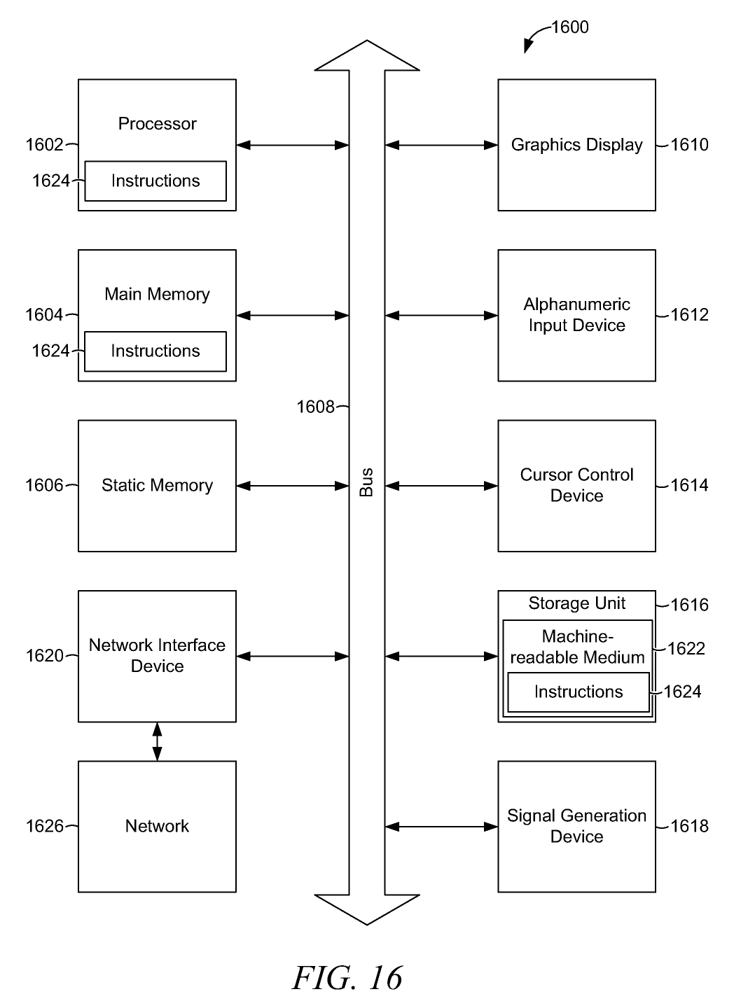

FIG. 11 is a network diagram illustrating a network environment 1100 suitable for facilitating a photographic social game, according to some example embodiments. The network environment 1100 includes a game machine 1110, a social media service server machine 1120, and devices 1130, 1140, and 1150, all communicatively coupled to each other via a network 1190. Any one or more of the machines or devices shown in FIG. 11 may be implemented in a computer system, as described below with respect to FIG. 16.

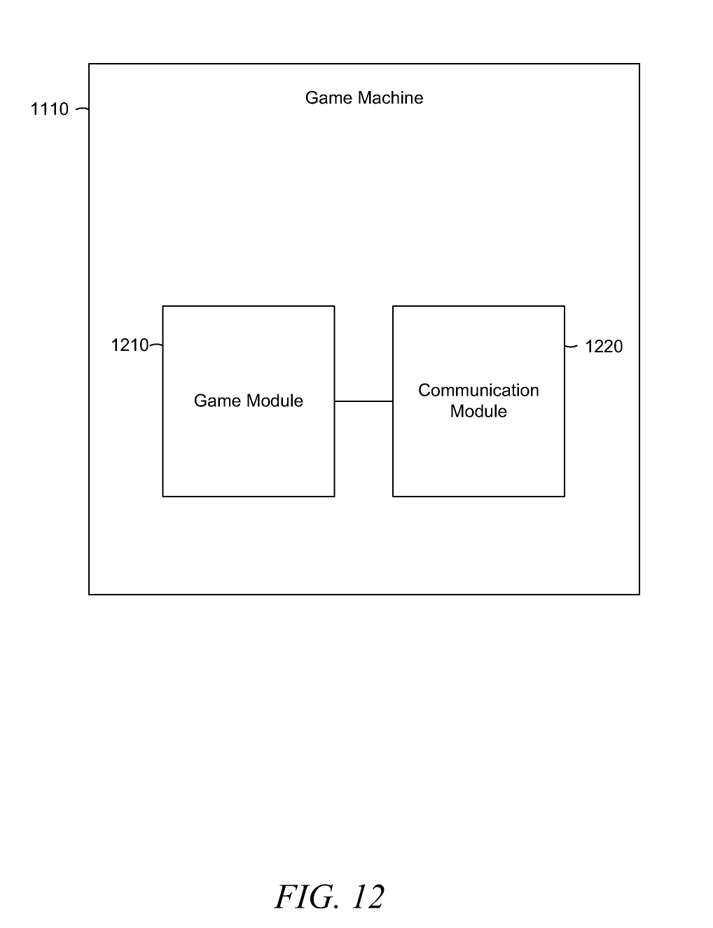

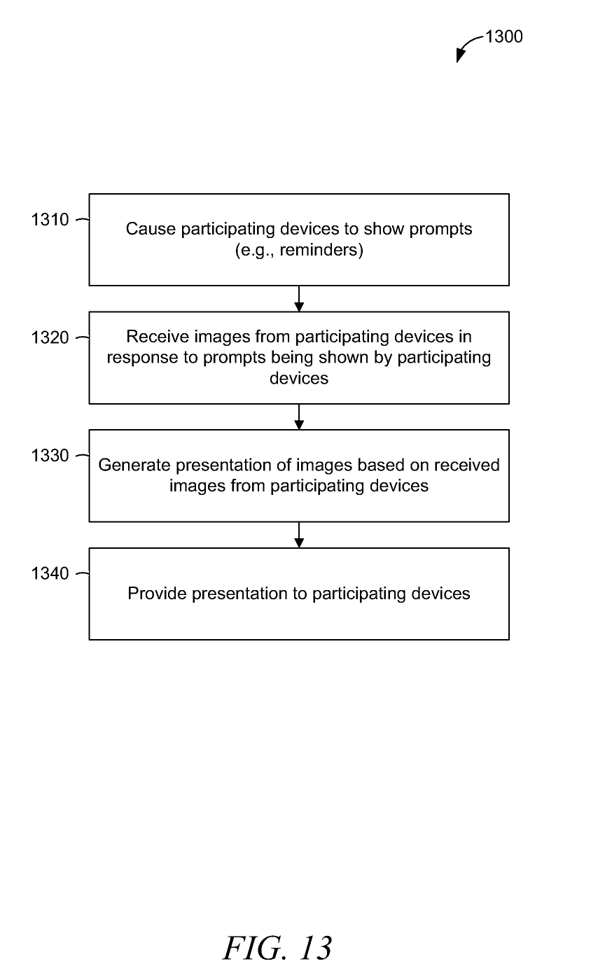

Example embodiments of the game machine 1110 are described below with respect to FIG. 12. Moreover, the game machine 1110 may perform any one or more operations of a method described below with respect to FIG. 13-15.

The social media service server machine 1120 is configured to provide one or more social media services to various users (e.g., contributory users participating in a particular instance of a photographic social game). Examples of social media services include Facebook®, Flickr®, Twitter®, Picassa®, and MySpace®. The social media service server machine 1120 may support sharing of information (e.g., presentation 900) among a group of users of a social media service that is provided by the social media service server machine 1120.

Also shown in FIG. 11 are users 1132, 1142, and 1152. One or more of the users 1132, 1142, and 1152 may be a human user (e.g., a human being), a machine user (e.g., software program configured to interact with the user device 1130), or any suitable combination thereof (e.g., a human assisted by a machine). The user 1132 is not part of the network environment 1100, but is associated with the user device 1130 and may be a user of the device 1130. For example, the device 1130 may be a deskside computer, a tablet computer, or a smart phone belonging to the user 1132. Likewise, the user 1142 is not part of the network environment 1100, but is associated with the device 1140. As an example, the device 1140 may be a cellular telephone or personal digital assistant (PDA) belonging to the user 1142. Similarly, the user 1152 is not part of the network environment 1100, but is associated with the device 1150. As an example, the device 1150 may be a tablet computer belonging to the user 1152. For purposes of a photographic social game (e.g., a particular instance of the photographic social game), the users 1132 and 1142 may be contributory users who use their respective devices 1130 and 1140 to submit images to the game machine 1110, and the user 1152 may be a non-contributory user who makes no submission of any image to the game machine 1110.

Any of the machines, databases, or devices shown in FIG. 11 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 16. As used herein, a “database” is a data storage resource and may store data structured as a text file, a table, a spreadsheet, a relational database, a triple store, or any suitable combination thereof. Moreover, any two or more of the machines illustrated in FIG. 11 may be combined into a single machine, and the functions described herein for any single machine may be subdivided among multiple machines.

The network 1190 may be any network that enables communication between machines (e.g., game machine 1110 and the device 1130). Accordingly, the network 1190 may be a wired network, a wireless network (e.g., a cellular network), or any suitable combination thereof. The network 1190 may include one or more portions that constitute a private network (e.g., a commercial network for paying customers), a public network (e.g., the Internet), or any suitable combination thereof.

FIG. 12 is a block diagram illustrating components of the game machine 1110, according to some example embodiments. The game machine 1110 includes a game module 1210 and a communication module 1220, which are configured to communicate with each other (e.g., via a bus, a shared memory, or a switch). Any one or more of the modules described herein may be implemented using hardware (e.g., a processor of a machine) or a combination of hardware and software. Moreover, any two or more of these modules may be combined into a single module, and the functions described herein for a single module may be subdivided among multiple modules.

The game module 1210 is a module as described below with respect to FIG. 16. The game module 1210 may configure a processor to perform one or more operations of a method discussed below with respect to FIG. 13-15. According to various example embodiments, the game module 1210 may be executed by the processor to perform one or more operations of the method discussed below with respect to FIG. 13-15. For example, the game module 1210 may cause, or configure the processor to cause, multiple devices (e.g., devices 1130 and 1140) to show one or more prompts (e.g., prompt 610) that are related to contribution of images toward generation of a presentation (e.g., presentation 820 or presentation 900) of images. As another example, the game module 1210 may receive, or configure the processor to receive, a set of images from the multiple devices in response to the one or more prompts being shown by the multiple devices. Each image in the set of images may be generated by one of the multiple devices subsequent to (e.g., in response to) one of the prompts being shown by that device. As a further example, the game module 1210 may generate, or configure the processor to generate, the presentation of images based on the set of images received from the multiple devices in response to the prompts caused to be shown by those devices. Further functionality of the game module 1210 is described below with respect to FIG. 13-15.

The communication module 1220 is a module as described below with respect to FIG. 16. The communication module 1220 may configure a processor to perform one or more operations of the method discussed below with respect to FIG. 13-15. According to various example embodiments, the communication module 1220 may be executed by the processor to perform one or more operations of the method discussed below with respect to FIG. 13-15. For example, the communication module 1220 may provide, or configure the processor to provide, the presentation generated by the game module 1210 (e.g., presentation 820 or presentation 900) to one or more of the multiple devices from which the set of images were received. Further functionality of the committee geisha module 420 is described below with respect to FIG. 13-15.

FIG. 13-15 are flowcharts illustrating operations in a method 1300 of facilitating a photographic social game (e.g., a particular instance of the photographic social game), according to some example embodiments. Operations in the method 1300 may be performed by the game machine 1110, using one or more modules described above with respect to FIG. 12.

As shown in FIG. 13, the method 1300 includes operations 1310, 1320, 1330, and 1340. In operation 1310, the game module 1210 causes one or more participating devices (e.g., devices 1130 and 1140) to show prompts (e.g., prompt 610) that are related to contribution of images toward the generation of a presentation (e.g., presentation 820 or presentation 900) of images. In some example embodiments, the prompts are the same for multiple participating devices. In certain example embodiments, the game module 1210 causes at least one of the participating devices to show a distinct (e.g., customized or unique) prompt. As noted above, one or more prompts may function as a reminder that a time is approaching at which an image is to be generated or submitted.

In operation 1320, the game module 1210 receives one or more images (e.g., a plurality of images) from the participating devices (e.g., devices 1130 and 1140) in response to the prompts being shown or caused to be shown by the participating devices in operation 1310. As noted above, each of the images may be generated by one of the participating devices subsequent to (e.g., in response to) one of the prompts being shown by that device.

In operation 1330, the game module 1210 generates the presentation (e.g., presentation 820 or presentation 900) of images based on (e.g., from) the one or more images received in operation 1320. The generating of the presentation may be in response to reception of the one or more images from the participating devices (e.g., devices 1130 and 1140).

In operation 1340, the communication module 1220 provides the presentation (e.g., presentation 820 or presentation 900) of images generated in operation 1330 to one or more of the participating devices (e.g., devices 1130 and 1140). For example, the communication module 1220 may communicate the presentation to the devices 1130 and 1140 using the network 1190.

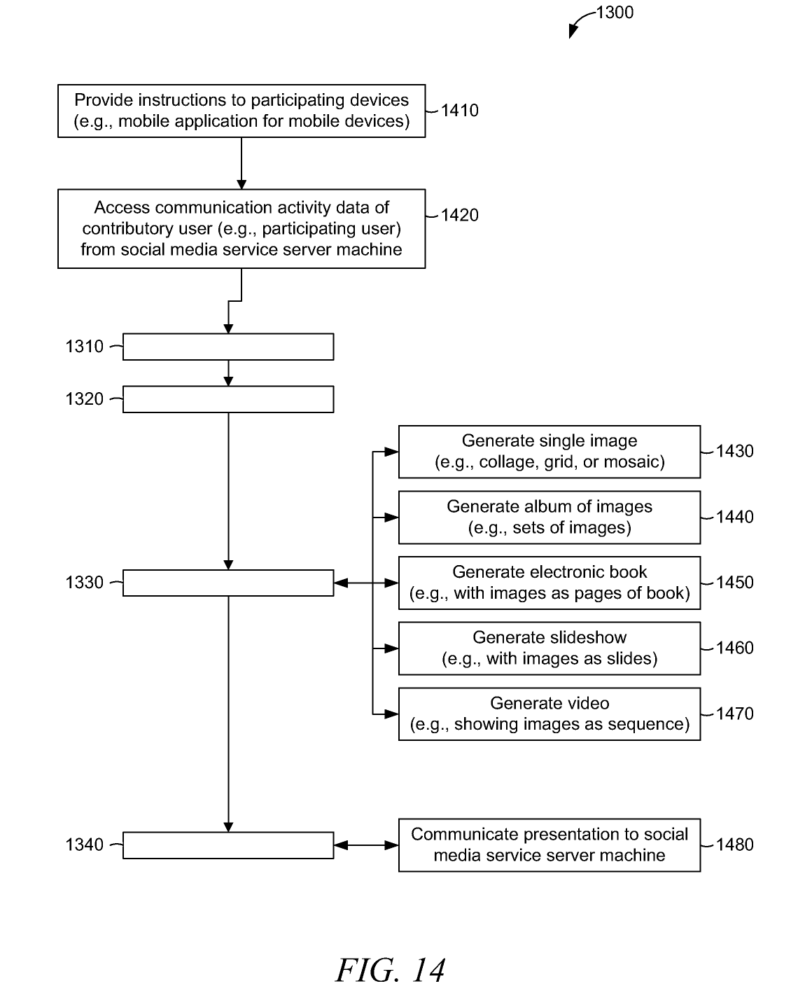

As shown in FIG. 14, the method 1300 may include one or more of operations 1410, 1420, 1430, 1440, 1450, 1460, 1470, and 1480. According to various example embodiments, one or more of the operations 1410 and 1420 are performed (e.g., by the communication module 1220) prior to the performance of operation 1310 by the game module 1210. In certain example embodiments, one or more of the operations 1430, 1440, 1450, 1460, and 1470 are performed by the game module 1210 as part of (e.g., a precursor task, a subroutine, or a portion of) the performance of operation 1330 by the game module 1210. According to some example embodiments, operation 1480 is performed by the communication module 1220 as part of, prior to, or subsequent to, the performance of operation 1440 by the communication module 1220.

In operation 1410, the communication module 1220 provides instructions to one or more of the participating devices (e.g., devices 1130 and 1140). As noted above, the instructions may cause a participating device (e.g., device 1130) to show a prompt (e.g., prompt 610) related to contributing images for the photographic social game (e.g., a particular instance of the photographic social game). For example, the communication module 1220 may act as a server module that provides a mobile application (e.g., a mobile app) to the device 1130 for execution by the device 1130, and the mobile application, when executed by the device 1130, may cause the device 1130 to show the prompt in response to the performance of operation 1310 by the game module 1210.

In operation 1420, the communication module 1220 accesses communication activity data of a contributory user (e.g., a user participating in a particular instance of the photographic social game). An example of a contributory user may be the user 1132 of the device 1130, where the user 1132 has been invited to participate in a particular instance of the photographic social game (e.g., invited to contribute an image to the particular instance of the photographic social game). The communication activity data may be accessed from the social media service server machine 1120 (e.g., accessed from a database hosted by the social media service server machine 1120). Examples of the communication activity data include a calendar of the contributory user, data from digital content and tools used by the contributory user (e.g., email, instant messaging, or phones), global positioning system (GPS) data of the contributory user, and social media data of the contributory user. According to certain example embodiments, the performance of operation 1310 by the game module 1210 is based on the communication activity data accessed in operation 1420. For example, the game module 1210 may perform operation 1310 in response to the determination that the user 1132 has a particular context as determined from the communication activity data.

As noted above, the presentation (e.g., presentation 820 or presentation 900) generated in operation 1330 may take the form of a single image in which the images received in operation 1320 are arranged as a collage, a grid, a mosaic, or any suitable combination thereof. In operation 1430, the game module 1210 generates the presentation as a single image, where the single image may be a collage, a grid, a mosaic, or any suitable combination thereof.

In some example embodiments, the presentation (e.g., presentation 820 or presentation 900) generated in operation 1330 takes the form of an album in which the images received in operation 1320 are arranged in groups (e.g., as multiple sets of multiple images). In operation 1440, the game module 1210 generates the presentation as an album, in which the images are arranged in groups (e.g., sets).

In certain example embodiments, the presentation generated in operation 1330 takes the form of an electronic book in which the images received in operation 1320 are arranged as pages of the electronic book. In operation 1450, the game module 1210 generates the presentation as an electronic book, in which the images are arranged as pages of the book.

In various example embodiments, the presentation generated in operation 1330 takes the form of a slideshow in which the images received in operation 1320 are arranged as slides in the slideshow. In operation 1460, the game module 1210 generates the presentation as a slideshow, in which the images are arranged as slides.

According to some example embodiments, the presentation takes the form of a video in which the images received in operation 1320 appear (e.g., one at a time or several at a time). In operation 1470, the game module 1210 generates the presentation as a video, in which the images are shown as a sequence of images.

In operation 1480, the communication module 1220 communicates the presentation (e.g., presentation 820 or presentation 900) to the social media service server machine 1120. The social media service server machine 1120 may be providing a social media service to one or more contributory users (e.g., user 1142), one or more non-contributory users (e.g., user 1152), or any suitable combination thereof. Accordingly, operation 1480 may have the effect of sharing the presentation with one or more contributory users, one or more non-contributory users, or any suitable combination thereof.

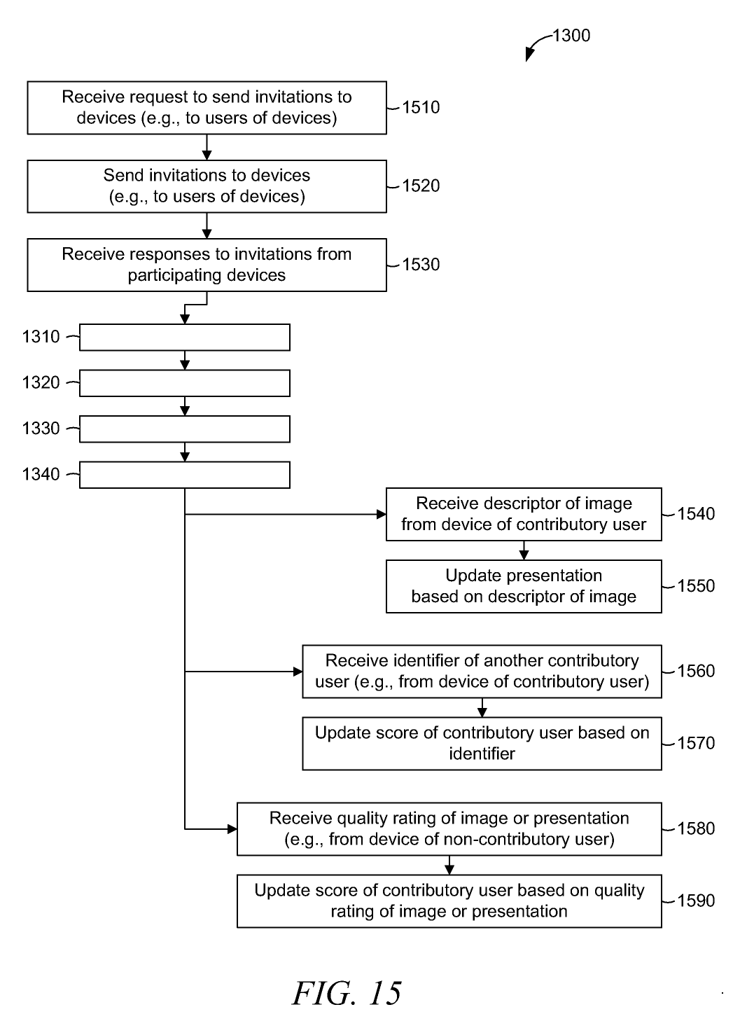

As shown in FIG. 15, the method 1300 may include one or more of operations 1510, 1520, 1530, 1540, 1550, 1560, 1570, 1580, and 1590. According to various example embodiments, one or more of the operations 1510, 1520, and 1530 may be performed (e.g., by the communication module 1220) prior to the performance of operation 1310 by the game module 1210. Operations 510-530 relate to organizing a particular instance of the photographic social game. In certain example embodiments, one or more of the operations 1540, 1550, 1560, 1570, 1580, and 1590 may be performed (e.g., by the communication module 1220) subsequent to performance of operation 1340 by the communication module 1220. Operations 1540-1590 relate to gameplay within a particular instance of the photographic social game, with respect to the presentation (e.g., presentation 820 or presentation 900) generated in operation 1330 and provided in operation 1340.

In operation 1510, the communication module 1220 receives a request to perform a communicating of invitations (e.g., a plurality of invitations) to one or more of various devices (e.g., devices 1130 and 1140). An example of these invitations is the invitation 510 discussed above with respect to FIG. 5. For example, the user 1132 may be an organizer of a particular instance of the photographic social game, and the user 1132 may use the device 1130 to initiate the particular instance of the photographic social game (e.g., by selecting parameters and inviting participants in a manner similar to that described above with respect to FIG. 2-3). Accordingly, the communication module 1220 may receive a request to send invitations to users (e.g., user 1142), where the invitations invite the users to become participants (e.g., contributory users) in the particular instance of the photographic social game. In certain example embodiments, the organizer invites or selects himself or herself to be a contributory user, and the request is accordingly received from a participating device (e.g., a device to be a participating device) in the particular instance of the photographic social game.

According to some example embodiments, one or more of the invitations (e.g., each of the invitations) specifies a topic for the images to be submitted by the contributory users (e.g., the images to be received by the game module 1210 in operation 1320). Hence, in these example embodiments, each of the images received in operation 1320 may be pertinent to the specified topic, and the presentation (e.g., presentation 820 or presentation 900) generated in operation 1330 may be pertinent to the specified topic.

According to certain example embodiments, one or more of the invitations (e.g., each of the invitations) specifies a particular time at which at least one of the images to be received in operation 1320 is to be generated by at least one of the participating devices (e.g., devices to be participating devices). For example, an invitation (e.g., invitation 510) may specify that a photograph is to be taken at 5:32 PM.

According to various example embodiments, one or more of the invitations (e.g., each invitation) specifies a particular event after which at least one of the images to be received in operation 1320 is to be generated by at least one of the participating devices (e.g., device 1130). For example, an invitation (e.g., invitation 510) may specify that a photograph is to be taken five minutes after waking up (e.g., after the user 1132 wakes up).

In operation 1520, the communication module 1220 communicates the invitations to the various devices (e.g., devices 1130 and 1140). Operation 1520 may be performed in response to the request received in operation 1510. Accordingly, the communication module 1220 may send the invitations to the users (e.g., user 1142) as requested in the request received in operation 1510.

In operation 1530, the communication module 1220 receives responses (e.g., a plurality of responses) to the invitations communicated in operation 1520. The responses may be received from one or more of the various devices (e.g., devices 1130 and 1140) discussed above with respect to operation 1510. Operation 1530 may be performed in response to the communicating of the invitations in operation 1520. In certain example embodiments, the performance of operation 1310 by the game module 1210 is based on the responses (e.g., affirmative responses) received in operation 1530. For example, the game module 1210 may perform operation 1310 by causing prompts (e.g., prompt 610) to appear only on participating devices (e.g., device 1130) that sent affirmative responses to the communication module in operation 1530.

For purposes of illustrating example embodiments, operations 1540-1590 are presently described in the example context of the devices 1130 and 1140 being participating devices that correspond to contributory users (e.g., users 1132 and 1142 respectively). Furthermore, the operations 1540-1590 are presently described in the example context of a device 1150 being a non-participating device that corresponds to a noncontributory user (e.g., user 1152). Within this example context, in the performance of operation 1320, the game module 1210 receives the image 910 generated by the device 1130 (e.g., as submitted by the user 1132) and receives the image 920 (e.g., a further image) generated by the device 1140 (e.g., as submitted by the user 1140). The images 910 and 920, as noted above with respect to FIG. 9, appear in the presentation 900, which is generated by the game module 1210 in the performance of operation 1330 and which is provided by the communication module 1220 in the performance of operation 1340.

According to some example embodiments, the photographic social game, or a particular instance thereof, facilitates tagging the presentation 900 by contributory users. In operation 1540, the game module 1210 receives a descriptor (e.g., a tag) from the device 1130 as a submission of the user 1132. The descriptor describes the image (e.g., image 910) received from the device 1130 in operation 1320. For example, the user 1132 may be named “Ruth,” and the game module 1210 may receive the name “Ruth” as a submitted tag indicating that Ruth is the photographer who took the image 910 that appears within the presentation 900.

In operation 1550, the game module 1210 updates the presentation 900 based on the descriptor received in operation 1540. For example, the game module 1210 may add the descriptor to the presentation 900. Accordingly, the communication module 1220 may provide the updated presentation 900 in a manner similar to that described above with respect to operation 1340.

According to certain example embodiments, the photographic social game, or a particular instance thereof, involves a guessing game in which a contributory user attempts to guess who photographed one or more images (e.g., image 920) appearing in the presentation 900. In operation 1560, the game module 1210 receives an identifier (e.g., a name or username) from the device 1130, as a submission of the user 1132. The identifier identifies the user 1142, and the identifier is received as a guess (e.g., an assertion) that the user 1142 is the photographer who took the image 920 that appears within the presentation 900. This guess may be correct or incorrect.

In operation 1570, the game module 1210 updates a score (e.g., a stored value representing a number of points) of the user 1132. The score may be updated based on the identifier received as a submission of the user 1132 in operation 1560. For example, if the identifier is a correct guess, the score may be updated by increasing its value by a predetermined number of points or according to a predetermined formula for calculating the resulting value of the score. As another example, if the identifier is an incorrect guess, the score may be updated by decreasing its value by a predetermined number of points or according to a predetermined formula. In some example embodiments, an incorrect guess results in no change to the score of the user 1132.

According to various example embodiments, the photographic social game, or a particular instance thereof, involves receiving ratings of images (e.g., image 910) appearing in the presentation 900 and awarding points based on the received ratings. Ratings may be received by contributory users (e.g., user 1142), non-contributory users (e.g., user 1152), or any suitable combination thereof. For clarity, the present discussion of operations 1580 and 1590 focuses on a rating received from a non-contributory user. Certain example embodiments, however, support a rating received from a contributory user in a similar or analogous manner.

In operation 1580, the game module 1210 receives a rating from the device 1150 as a submission of the user 1152. The user 1152 is a non-contributory user who submitted none of the images received by the game module in operation 1320. In some example embodiments, the rating is indicative of a quality of the image 910 submitted by the user 1132 (e.g., a subjective indication of the quality of the image 910, as determined or opined by the user 1152). In various example embodiments, the rating is indicative of a quality of the presentation 900 generated by the game module 1210 (e.g., subjective indication of the quality of the presentation 900, as determined or opined by the user 1152). In various example embodiments, the rating indicates how much that a user 1152 likes or dislikes the image 910 or the presentation 900.

In operation 1590, the game module 1210 updates the score (e.g., the number of points) of the user 1132 based on the rating received in operation 1580. For example, where the rating indicates a quality of the image 910, the score of the user 1132 may be raised, left unchanged, or lowered as a reward or consequence of submitting the image 910 for this particular instance of the photographic social game. As another example, where the rating indicates a quality of the presentation 900, the score of the user 1132 may be raised, left unchanged, or lowered as a reward or consequence of participating in (e.g., contributing to) this particular instance of the photographic social game.

According to various example embodiments, one or more of the methodologies described herein may facilitate entertainment, amusement, competition, publicity, enjoyment, or any suitable combination thereof, for any number of users (e.g., users 1132, 1142, or 1152). In particular, one or more of the methodologies described herein may constitute all or part of a game (e.g., a social media game), all or part of a business method (e.g., a business method implemented using a machine), or both.

When these effects are considered in aggregate, one or more of the methodologies described herein may obviate a need for certain efforts or resources that otherwise would be involved in facilitating the entertainment, amusement, competition, publicity, enjoyment, or any suitable combination thereof, for various users. Effort and time expended by a game organizer in facilitating a particular instance of a photographic social game may be reduced by one or more of the methodologies described herein. Computing resources used by one or more machines, databases, or devices (e.g., within the network environment 1100) may similarly be reduced. Examples of such computing resources include processor cycles, network traffic, memory usage, data storage capacity, power consumption, and cooling capacity.

FIG. 16 illustrates components of a machine 1600, according to some example embodiments, that is able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system and within which instructions 1624 (e.g., software) for causing the machine 1600 to perform any one or more of the methodologies discussed herein may be executed. In alternative embodiments, the machine 1600 operates as a standalone device or may be connected (e.g., networked) to other machines. In a networked deployment, the machine 1600 may operate in the capacity of a server machine or a client machine in a server-client network environment, or as a peer machine in a peer-to-peer (or distributed) network environment. The machine 1600 may be a server computer, a client computer, a personal computer (PC), a tablet computer, a laptop computer, a netbook, a set-top box (STB), a PDA, a cellular telephone, a smartphone, a web appliance, a network router, a network switch, a network bridge, or any machine capable of executing the instructions 1624 (sequentially or otherwise) that specify actions to be taken by that machine. Further, while only a single machine is illustrated, the term “machine” shall also be taken to include a collection of machines that individually or jointly execute the instructions 1624 to perform any one or more of the methodologies discussed herein.

The machine 1600 includes a processor 1602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1604, and a static memory 1606, which are configured to communicate with each other via a bus 1608. The machine 1600 may further include a graphics display 1610 (e.g., a plasma display panel (PDP), a liquid crystal display (LCD), a projector, or a cathode ray tube (CRT)). The machine 1600 may also include an alphanumeric input device 1612 (e.g., a keyboard), a cursor control device 1614 (e.g., a mouse, a touchpad, a trackball, a joystick, a motion sensor, or other pointing instrument), a storage unit 1616, a signal generation device 1618 (e.g., a speaker), and a network interface device 1620 (e.g., communication module 1220).

The storage unit 1616 includes a machine-readable medium 1622 on which is stored the instructions 1624 (e.g., software) embodying any one or more of the methodologies or functions described herein. The instructions 1624 may also reside, completely or at least partially, within the main memory 1604, within the processor 1602 (e.g., within the processor's cache memory), or both, during execution thereof by the machine 1600. Accordingly, the main memory 1604 and the processor 1602 may be considered as machine-readable media. The instructions 1624 may be transmitted or received over a network 1626 (e.g., network 1190) via the network interface device 1620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1622 is shown in an example embodiment to be a single medium, the term “machine-readable medium” should be taken to include a single medium or multiple media (e.g., a centralized or distributed database, or associated caches and servers) able to store instructions (e.g., instructions 1624). The term “machine-readable medium” shall also be taken to include any medium that is capable of storing instructions (e.g., software) for execution by the machine, such that the instructions, when executed by one or more processors of the machine (e.g., processor 1602), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
causing a plurality of devices to show a plurality of prompts related to contribution of images toward generation of a presentation of images;
receiving a plurality of images from the plurality of devices in response to the plurality of prompts being shown by the plurality of devices,
each of the plurality of images being generated by one of the plurality of devices subsequent to one of the plurality of prompts being shown by the one of the plurality of devices;
generating the presentation of images based on the plurality of images received from the plurality of devices in response to the plurality of prompts caused to be shown by the plurality of devices,
the generating of the presentation being performed by a processor of a machine; and
providing the presentation to the plurality of devices from which the plurality of images were received.

2. The method of claim 1, wherein: [types of group output]
the generating of the presentation of the plurality of images generates the presentation in a form selected from a group consisting of:
a single image in which the plurality of images is arranged as a collage,
a single image in which the plurality of images is arranged as a grid,
a single image in which the plurality of images is arranged as a mosaic,
an album in which the plurality of images is arranged as multiple sets of multiple images,
an electronic book in which the plurality of images is arranged as multiple pages of the electronic book,
a slideshow in which the plurality of images is arranged as multiple slides of the slideshow, and
a video in which the plurality of images appear.

3. The method of claim 1 further comprising: [mobile app]
providing instructions to the plurality of devices,
the instructions facilitating the causing of the plurality of devices to show the plurality of prompts.

4. The method of claim 1, wherein: [individual participant]
a device among the plurality of devices corresponds to a contributory user who submitted an image among the plurality of images.

5. The method of claim 4 further comprising: [reminder based on social media]
accessing communication activity data of the contributory user from a server machine that is providing a social media service to the contributory user; and wherein
the causing of the plurality of devices to show the plurality of prompts is based on the communication activity data of the contributory user.

6. The method of claim 4, wherein: [sharing group output via social media]
the providing of the presentation to the plurality of devices includes communicating the presentation to a server machine that is providing a social media service to the contributory user.

7. The method of claim 4 further comprising: [tagging by participant]
receiving a descriptor of the image from the device as a submission of the contributory user; and
updating the presentation based on the descriptor of the image.

8. The method of claim 4 further comprising: [guessing game]
receiving an identifier as a further submission of the contributory user,
the identifier identifying a further contributory user who submitted a further image of the plurality of images; and
updating a score of the contributory user based on the further submission of the contributory user.

9. The method of claim 4 further comprising: [non-participant rating image]
receiving a rating of the image as a submission of a non-contributory user who submitted none of the plurality of images,
the rating being indicative of a quality of the image submitted by the contributory user; and
updating a score of the contributory user based on the rating of the image.

10. The method of claim 1, wherein: [non-participant rating group output]
a device corresponds to a non-contributory user who submitted none of the plurality of images; and the method further comprises
receiving a rating of the presentation from the device as a submission of the non-contributory user,
the rating being indicative of a quality of the presentation generated based on the plurality of images.

11. The method of claim 10, wherein: [awarding points for group output]
a device among the plurality of devices corresponds to a contributory user who submitted an image among the plurality of images; and the method further comprises
updating a score of the contributory user based on the rating of the presentation.

12. The method of claim 1 further comprising: [organizing game]
receiving a plurality of responses to a plurality of invitations to contribute to the generating of the presentation,
the plurality of responses being received from the plurality of devices; and wherein
the causing of the plurality of devices to show the plurality of prompts is based on the receiving of the plurality of responses to the plurality of invitations.

13. The method of claim 12, wherein: [game with theme]
each of the plurality of invitations specifies a topic for the plurality of images;
each of the plurality of images is pertinent to the topic; and
the presentation of images is pertinent to the topic.

14. The method of claim 12, wherein: [time trigger]
each of the plurality of invitations specifies a particular time at which at least one of the plurality of images is to be generated by at least one of the plurality of devices.

15. The method of claim 12, wherein: [event trigger]
each of the plurality of invitations specifies a particular event after which at least one of the plurality of images is to be generated by at least one of the plurality of devices.

16. The method of claim 12 further comprising: [inviting participants]
communicating the plurality of invitations to the plurality of devices; and wherein
the receiving of the plurality of responses is in response to the communicating of the plurality of invitations.

17. The method of claim 16 further comprising: [organizer initiates game]
receiving a request to perform the communicating of the plurality of invitations to the plurality of devices; and wherein
the communicating of the plurality of invitations is in response to the receiving of the request.

18. The method of claim 17, wherein: [organizer is participant]
the request to perform the communicating of the plurality of invitations is received from a device among the plurality of devices.

19. A non-transitory machine-readable storage medium comprising instructions that, when executed by one or more processors of a machine, cause the machine to perform operations comprising:
causing a plurality of devices to show a plurality of prompts related to contribution of images toward generation of a presentation of images;
receiving a plurality of images from the plurality of devices in response to the plurality of prompts being shown by the plurality of devices,
each of the plurality of images being generated by one of the plurality of devices subsequent to one of the plurality of prompts being shown by the one of the plurality of devices;
generating the presentation of images based on the plurality of images received from the plurality of devices in response to the plurality of prompts caused to be shown by the plurality of devices,
the generating of the presentation being performed by a processor of a machine; and
providing the presentation to the plurality of devices from which the plurality of images were received.

20. A system comprising:
a processor configured by a game module, the game module configuring the processor to:
cause a plurality of devices to show a plurality of prompts related to contribution of images toward generation of a presentation of images;
receive a plurality of images from the plurality of devices in response to the plurality of prompts being shown by the plurality of devices,
each of the plurality of images being generated by one of the plurality of devices subsequent to one of the plurality of prompts being shown by the one of the plurality of devices; and
generate the presentation of images based on the plurality of images received from the plurality of devices in response to the plurality of prompts caused to be shown by the plurality of devices; and
means for providing the presentation to the plurality of devices from which the plurality of images were received.
